(19) United States
(12) Patent Application Publication
(10) Pub. No.: US 2018/0231991 A1
(43) Pub. Date: Aug. 16, 2018

(54) Oscillating a Plurality of Proportional Valves

(71) Applicants: Larry Baxter, Orem, UT (US); Eric Mansfield, Spanish Fork, UT (US); Kyler Stitt, Lindon, UT (US); Stephanie Burt, Provo, UT (US); Christopher Hoeger, Provo, UT (US)

(72) Inventors: Larry Baxter, Orem, UT (US); Eric Mansfield, Spanish Fork, UT (US); Kyler Stitt, Lindon, UT (US); Stephanie Burt, Provo, UT (US); Christopher Hoeger, Provo, UT (US)

(21) Appl. No.: 15/431,264

(22) Filed: Feb. 13, 2017

(51) Int. Cl. G05D 7/06; F16K 31/02; F16K 37/00; G05B 13/02

(52) U.S. Cl. CPC G05D 7/0652; G05B 13/021; F16K 37/0083; F16K 31/02

(57) ABSTRACT

A system, and a method, are disclosed with a plurality of valves acting as a group. The valves of the group are instructed by a master controller or other device to oscillate more open and more closed around a set point. The system controls the oscillation using an instruction to oscillate in a sine waveform pattern; the valves of the group oscillate so that the sine waveform is a positive phase shift of at least one other valve in the group. The phase shift may be calculated as 360/n degrees, where n represents the number of valves in the group.

This invention was made with government support under DE-FE0028697 awarded by The Department of Energy. The government has certain rights in the invention.

### CROSS-REFERENCE TO RELATED APPLICATIONS

This application does not claim the benefit of other applications.

### TECHNICAL FIELD

The present disclosure relates to methods and systems for responding to sustainability challenges in the energy industry, including carbon capture technologies, natural gas treatment, carbon dioxide storage, and heat exchangers. Specifically, the disclosure relates to controlling the flow or transfer of liquids, mixtures, gases, and super-fluids through valves.

### BACKGROUND

Methods and apparatuses for controlling the flow rate of a valve are quite wide-spread; however, many unsolved problems exist, including the challenges of dealing with hysteresis and stiction. Hysteresis, in relation to a valve, is a delta in the position of a valve for a certain input signal at the upstroke as compared to the position of the valve at the downstroke. See http://www.processindustryforum.com/. Hysteresis may be caused by a high amount of static friction within a valve. See http://www.processindustryforum.com/. Stiction is a threshold of static friction that must be overcome before two objects in contact will move. “A control valve is a valve used to control fluid flow by varying the size of the flow passage as directed by a signal from a controller. This enables the direct control of flow rate and the consequential control of process quantities such as pressure, temperature, and liquid level.” See Wikipedia citing Fisher Control Valve Handbook, 4th edition, published 1977.

“A valve actuator is the mechanism for opening and closing a valve. Manually operated valves require someone in attendance to adjust them using a direct or geared mechanism attached to the valve stem. Power-operated actuators, using gas pressure, hydraulic pressure or electricity, allow a valve to be adjusted remotely, or allow rapid operation of large valves. Power-operated valve actuators may be the final elements of an automatic control loop which automatically regulates some flow, level or other process. Actuators may be only to open and close the valve, or may allow intermediate positioning; some valve actuators include switches or other ways to remotely indicate the position of the valve.” See Wikipedia. Four types of actuators are common: manual, pneumatic, hydraulic, and electric. See Wikipedia. In general, some force is generated whether by pressure, fluid pressure, air pressure, electrical means and that may act on some physical component, such as a valve stem, gear, ball, or other object which results in the direct or indirect blockage of the valve passageway.

In a valve, the positioner may be linked to an actuator. “A valve positioner is a device used to increase or decrease the air load pressure driving the actuator of a control valve until the valve's stem reaches a position balanced to the output signal from the process variable instrument controller.” See www.instrumentationtoolbox.com. When a master controller, which is a specialized type of server, instructs a valve positioner to change the pressure driving the actuator, there may be some slippage so that the valve does not turn immediately after the instruction to change the pressure. This slippage may cause a delay, and the actual open-close values of the valve will then be different than the intended open-close value. In some cases, a user might set the set point of the valve for 50% open and the valve may actually open to 48% and then vary between the range of 48% to 52%.

U.S. Pat. No. 3,709,253, the contents of which are incorporated by reference, discloses a method for using a dithering pattern for interacting with hysteresis. As the flow rate approaches the desired value, the system of the '253 patent then decreases the dithering.

FIG. 1 depicts the prior art. The X axis represents time and may be in any commonly used units such as seconds, nanoseconds, milliseconds, and minutes. The Y-axis represents the percentage in which the valve is open, with the bottom of the Y-axis representing a valve that is 0% open and the top of the Y-axis representing a valve that is 100% open. FIG. 1 depicts a scenario that has been known in the past. The continuous line represents a set point position, which is the theoretical or desired open-close state of a valve. The dotted line represents the actual open-close valve positions over time when a valve is instructed to open and close at the set point position, which does not match the theoretical or desired open-close curve.

Given that hysteresis and stiction slow a valve so that the actual open and close positions of a valve lag behind the desired open-close values, as instructed by a master controller, a need still exists for improved methods and apparatuses for more closely aligning the actual open-close positions of a valve with the desired open-close positions of a valve.

### BRIEF SUMMARY

The present disclosure describes methods and systems for overcoming hysteresis and stiction in valves. Valves are oscillated between a closed or open position. In some embodiments, the valves are oscillated between a relatively closed position and a relatively open position. For example, a valve that is 20% open is relatively closed; then when the valve moves to 80% open the valve is relatively open.

An embodiment includes controlling one of more valves which determine the flow of streams of gases, liquids, super-fluids, or similar substances into a vessel such as a heat chamber. Another embodiment includes controlling the rate a liquid, such as liquid nitrogen, flows into a chamber of a vessel. An embodiment of a disclosed invention may include a valve for controlling the level of liquid vapor that enters or exits a liquid vapor separator. An embodiment of the disclosed invention may include a valve located in the gas outlet of a liquid-liquid separator or a liquid-gas separator.

The disclosed system includes hardware for moving a positioner and an actuator from open to closed positions and vice-versa. Types of valves that may be used include a proportional valve, a ball valve, or other type of valve used for controlling the flow of liquids or gases.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the accompanying drawings in which:

FIG. 1 depicts the prior art and is a schematic diagram of a graph representing the signal sent to a valve and a graph depicting the actual response of the valve to the signal;

FIG. 2 is a schematic diagram of a two-valve system for transporting liquid nitrogen;

FIG. 2B is a schematic diagram of an array of two valves using the disclosed method to control the opening and closing of the valves;

FIG. 3 is a detailed schematic of portions of FIG. 2, which also shows the sine waves representative of the opening and closing of the valves;

FIG. 4 illustrates 3 different waves which are used to control the valves;

FIG. 5 illustrates three distinct sine wave curves, each representing the oscillating instruction given to one valve in an array of 3 valves;

FIG. 5B is a schematic diagram showing a single conduit branching into a total of three conduits, the three conduits each including a valve.

### DETAILED DESCRIPTION

The following embodiments are illustrative:

The set point is the target average open position for a valve; for an oscillating valve, a server instructs the valve to oscillate between an upper threshold, such as 55% open, and a lower threshold, such as 45% open, around the set point. In the preferred embodiments, the valve is briefly opened to the set point as the modulating element, which may be used to block the aperture of the valve, is oscillated so that the valve is opened to an upper threshold that is a certain percentage above the set point and then closed to a lower threshold that is a certain percentage below the set point.

A method for overcoming hysteresis and stiction in a plurality of N valves is disclosed. The method comprises: providing a total of N valves, wherein N is less than 101 and is equal to the total number of valves in the plurality of N valves, directly coupled by a single conduit which branches and feeds into each valve of the N valves, wherein each valve of the N valves comprises a body, an aperture area disposed within the body and defining an aperture, a modulating element disposed within the body and configured to occlude a percentage of the aperture, the positioner, the actuator, and the aperture area; determining a set point for the plurality of N valves which is between 5% fully-opened and 90% fully-opened; determining an upper threshold substantially equal to 100% minus the percentage of the aperture occluded by the modulating element for the plurality of N valves; determining a lower threshold substantially equal to 100% minus the percentage of the aperture occluded by the modulating element for the plurality of N valves; oscillating each valve of the plurality of N valves, according to an instruction received from a server to oscillate according to a Nth valve oscillating pattern, continuously for a time interval, back and forth from an upper threshold (for the percentage that the aperture is opened as compared to the maximum value that the aperture may be opened) to a lower threshold, wherein the average of the upper threshold and the lower threshold is substantially equal to a set point; arranging the oscillating pattern, which may be a sine wave pattern, for each valve of the plurality of N valves in temporal order so that a first instant in time at which the first valve of the plurality of N valves begins to transition from the upper threshold to the lower threshold is temporally followed, at a second instant in time, by a second valve of the plurality of N valves beginning to transition from the upper threshold to the lower threshold so that the phase shift as measured between the oscillating pattern of the first valve at the first instant in time and the oscillating pattern of the second valve at the second instant in time substantially equals 360/N degrees, wherein the phase shift between the Nth valve and the first valve is substantially equal to 360/N degrees. The oscillating pattern may follow a sine wave, and the first oscillating pattern for a first valve that differs by a phase shift of 180 degrees from a second oscillating pattern of a second valve may be shifted to overlap the second oscillating pattern when the oscillating pattern is moved 180 degrees forward, where 360 degrees represents an entire cycle of a sine wave of an oscillating pattern.

In yet another method, the number of oscillating valves equals 2, the phase shift equals 180 degrees, and the instruction received from a control system is received wirelessly. The valves may have sensors and receivers for receiving the wireless instruction.

In yet another method, the number of oscillating valves equals 3 and the phase shift between the second valve and the first valves is 120 degrees; the phase shift between the third valve and the second valve may equal 120 degrees.

In yet another method, first valve, second valve, and third valve are proportional valves arranged in a parallel alignment, further including the step of outputting the set point from a PID controller and tuning the first valve, second valve, and third valve. A control system may select various set points, upper thresholds, and lower thresholds, for a group of oscillating valves and then may test the output of a liquid or gas or other type of substance through the group of oscillating valves; the control system may then measure the total output through the valves and select the combination of setpoint, upper threshold, and lower threshold which results in total output closes to a desired total output.

In yet another method, the phase shift equals 360/N degrees, where N equals the number of valves in a group of oscillating valves, minus a certain quantity of degrees between 0.1 degrees and 7 degrees. In some systems, a group of valves may not all be identical, and some of the valves may suffer more from stiction and hysteresis than the other valves in the group. By using 360/N−a number between 0.1 degrees and 25 degrees, the method may be able to compensate for the differences in the valves such that the total output of the valves may be closer to the theoretical output for a system using theoretically identical valves. Tuning may be used to determine the desired parameters.

In yet another method, a method for oscillating valves further comprises the steps of monitoring, via a sensor, the actual aperture areas of the first valve and the second valve; comparing, via a server, the actual aperture areas of the first valve and the second valve to the set point.

In yet another method, the method comprises the steps of providing a jumbo valve comprising the first valve and the second valve, wherein the first valve and the second valve reside in a single casing. A plurality of valves may function as a single unit and may reside in a single casing called a jumbo patent.

In yet another method, the number of valves equals 2, and wherein the set point value of the first valve is between 1.01 and 4 times larger than the set point of the second valve.

An apparatus for overcoming hysteresis and stiction is disclosed; the apparatus comprising: a plurality of N oscillating valves in a group, grouped by proximity, input conduit or identical substance passing through the valves, wherein N is equal to the total number of valves in the plurality of valves, wherein each valve of the plurality of N oscillating valves comprises a positioner, an actuator, and an aperture area and each of the N oscillating valves is configured to oscillate at a phase shift of 360/N degrees from at least one of the other valves in the group; a server communicatively coupled to a processor; the processor communicatively-coupled to a non-transitory data storage unit; the non-transitory data storage unit comprising computer code that, when executed by the processor, causes the processor to: determine a set point for the plurality of N valves which is between 5% fully-opened and 90% fully-opened; determine an upper threshold substantially equal to 100% minus the percentage of the aperture occluded by the modulating element for the plurality of N valves; determine a lower threshold substantially equal to 100% minus the percentage of the aperture occluded by the modulating element for the plurality of N valves; instruct, via a server, each valve of the plurality of N valves, to oscillate according to a Nth valve oscillating pattern, continuously for a time interval which may between 0.0001 seconds and 10,000000 seconds (but in the preferred embodiments may be between 2 seconds and 24 hours), back and forth from an upper threshold (for the percentage that the aperture is opened as compared to the maximum value that the aperture may be opened) to a lower threshold, wherein the average of the upper threshold and the lower threshold is substantially equal to a set point; arranging the oscillating pattern for each valve of the plurality of N valves in temporal order so that a first instant in time at which the first valve of the plurality of N valves begins to transition from the upper threshold to the lower threshold is temporally followed, at a second instant in time, by a second valve of the plurality of N valves beginning to transition from the upper threshold to the lower threshold so that the phase shift as measured between the oscillating pattern of the first valve at the first instant in time and the oscillating pattern of the second valve at the second instant in time substantially equals 360/N degrees, wherein the phase shift between the Nth valve and the first valve is substantially equal to 360/N degrees. When there are 5 valves, then the first valve's oscillating pattern may be a phase shift of the fifth valve's oscillating pattern, the fifth valve's oscillating pattern may be a phase shift of the fourth valve's oscillating pattern; the fourth valve's oscillating pattern may be a phase shift of the third valve's oscillating pattern; the third valve's oscillating pattern may be a phase shift of the second valve's oscillating pattern, the second valve's oscillating pattern may be a phase shift of the first valve's oscillating pattern.

In yet another embodiment, for two oscillating valves, the first phase shift is 180 degrees.

In yet another embodiment of an apparatus, the apparatus further comprises a third valve, the non-transitory data storage medium further storing programmable instructions for continuously oscillating the third valve, using an oscillating pattern, from the upper threshold to the lower threshold, wherein the phase shift between the first oscillation pattern and the second oscillation pattern is 120 degrees, wherein the phase shift between the second oscillation pattern and the third oscillation pattern is 120 degrees.

In yet another embodiment, the apparatus comprises a first valve, second valve, and third valve which are proportional valves arranged in a parallel alignment; the apparatus further comprises a proportional-integral-derivative controller configured to output a data value equal to the set point.

In yet another embodiment, the apparatus has a set point between 47% and 53%.

In yet another embodiment, the apparatus has a server with a non-transitory storage; instructions on the non-transitory storage are for instructing the valves to oscillate in such timing that the phase shift is defined as ((360 degrees divided by N) minus a number of degrees between 0.1 degrees and 7 degrees) or between 0.01 and 95 degrees.

In yet another embodiment, the apparatus further comprising the steps of monitoring, via a sensor, the actual aperture areas of the first valve and the second valve; comparing, via a server, the actual aperture areas of the first valve and the second valve to the set point.

In yet another embodiment of the apparatus wherein N equals 2, further comprising a jumbo valve, the jumbo valve consisting of a casing surrounding the first valve and the second valve. The jumbo valve may have an arm that has one end that is communicatively coupled to the actuator of the first valve and a second arm that is communicatively coupled to the actuator of the second valve.

In yet another embodiment of the apparatus wherein the difference between the upper threshold and the set point is between 0.1% and 11% and (or between 0.1% and 40%) the difference between the set point and the lower threshold is between 0.1% and 11% (or between 0.1% and 40%, wherein in the most preferred embodiments the difference between the upper threshold and the set point is substantially equal to the difference between the set point and the lower threshold), and wherein the non-transitory medium stores instructions for setting the set point of the second valve to be between 1.1 and 1.3 times larger than the set point of the first valve.

In yet another embodiment, an apparatus for overcoming hysteresis and stiction is disclosed; the apparatus comprising: at least two valves, wherein each valve of the at least two valves comprises a positioner, an actuator, and an aperture area; a processor communicatively-coupled to a non-transitory data storage unit; the non-transitory data storage unit comprising computer code that, when executed by the processor, causes the processor to determine or confirm a set point for the valve which is between 25% and 67%.

In yet another embodiment, the apparatus has a set point for the valve that is between 30% and 62%. In yet another embodiment, the apparatus has a set point for the valve between 40% and 75%.

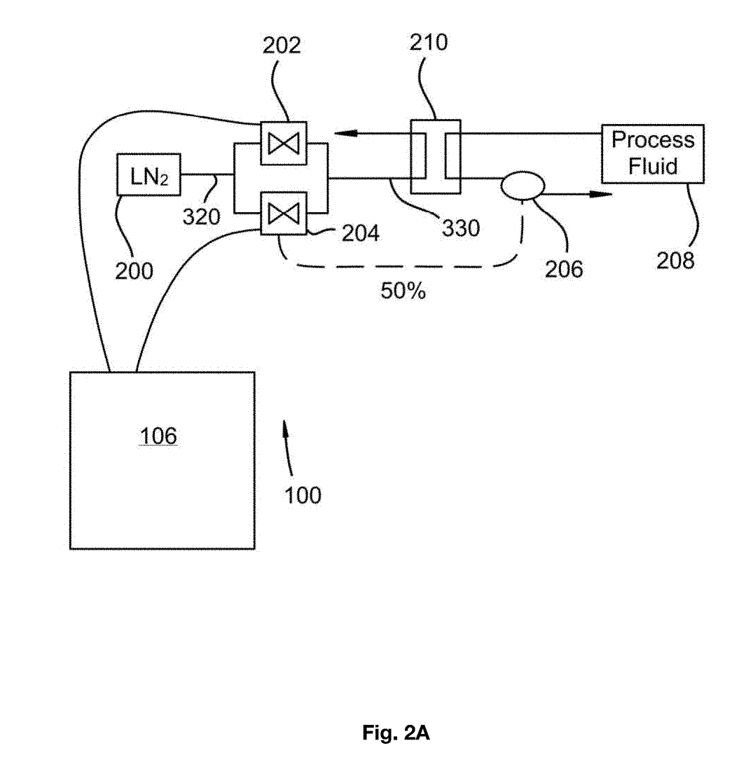

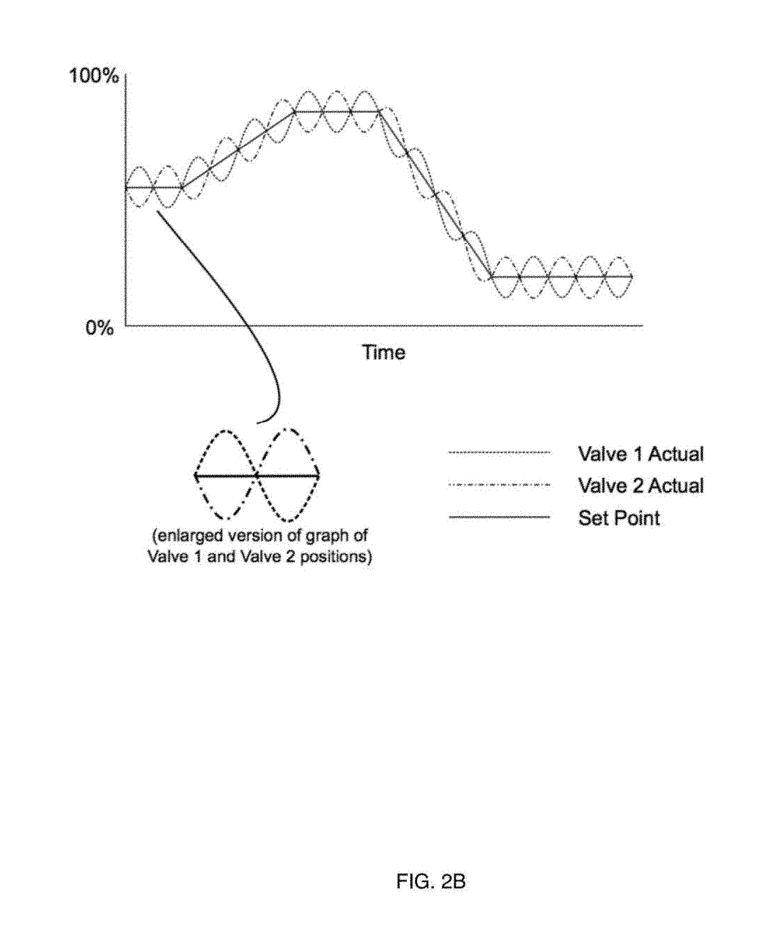

Referring to FIG. 2A, a schematic of a method of using the disclosed system for two valves. The system includes two or more valves which are grouped to open and close in coordination with the other valves of the group. The set point is depicted by a continuous line. The open close position for valve 1 oscillates by a certain margin value from the set point value so that at its peak the open percentage of valve 1 equals the set point plus the margin value and at its trough the open percentage of valve 1 equals the set point minus the margin value. The open percentage refers to the area of the aperture formed by the valve divided by the maximum area of the aperture that may be formed by a valve. For example, the maximum open percentage of valve is 100% and represents the area of the aperture that is formed when the valve is opened to its most open position. When a valve is closed to its most closed position, which in the preferred embodiments is fully closed, then the percentage open is 0%. If a valve is opened halfway between its fully opened position and its fully closed position, then the valve is 50% open. When the margin is 5%, then the valve will be oscillated between 45% open and 50% open, and a sine wave may represent the oscillating pattern of the valve. In FIG. 2A, a second valve's oscillating pattern is shown. An enlarged version of a portion of the graph is shown. The phase shift between the oscillating pattern of valve 1 and the oscillating pattern of valve 2 may be calculated by the formula of “phase shift=360/n degrees”; here, n equals 2 and the phase shift may be 180 degrees.

Referring to FIG. 2B, a heat exchanger system (100) with a plurality of valves is shown. A first vessel (200) which may contain fluids, such as liquid nitrogen, gases, or other types of substances, may allow for the transportation of the fluids or gases through two parallel valves. The two parallel valves may consist of a first valve (102) and a second valve (104). Although not shown in detail, a master controller (106), which is a specialized server and is described further in detail and may contain modules which have programmable code stored on a non-transitory storage medium coupled to a processor in which the modules perform one or more steps of the claimed methods and are named after the step or steps, may communicate with any or all of the components of the system, including the valves. Master controller (106) may be communicatively coupled by wire or wireless connector to any component system. In the preferred embodiments, the master controller (106) may be communicatively coupled to one or more of the valves, one or more of the valve positioners, or one or more of the valve actuators. A valve may have one or more sensors which are communicatively coupled to the master controller and may provide data on the open-closed state of the valve, such as percentage open or percentage closed, the flow rate of substances passing through the valve, the type of substance which passes through the valves, the temperature of the substances passing through the valves, the temperature of the valves, the pressure of the substances passing through the valves, and the pressure of the air in the valves. The first vessel (200) may contain any liquid or gas, and in the preferred embodiments contains liquid nitrogen.

A first valve is shown, as a well as a second valve. The valves may be proportional valves, ball valves, or other types of valves used in the described systems. In preferred embodiments the first valve and the second valve open and close following a sine wave pattern. The process for generating the sine wave pattern instructions will be described hereafter. In the preferred embodiments, a valve opens and then closes. The valves may fully open and close or may open a percentage of fully open or a percentage of fully closed. The time it takes to cycle, that is change from the most open state to the most closed state for a given routine, such as a routine that alternates between 20% open and 80% open, may vary. The time may be nanoseconds, may be milliseconds, may be seconds, or may be minutes. For example, the time it takes to cycle may be between 0.001 and 50000 milliseconds; in some embodiments the time it takes to cycle may be between 0.01 and 500 milliseconds, in some embodiments the time it takes to cycle may be between 0.1 and 50 milliseconds and in some embodiments the time it takes to cycle may be between 1 and 5 milliseconds.

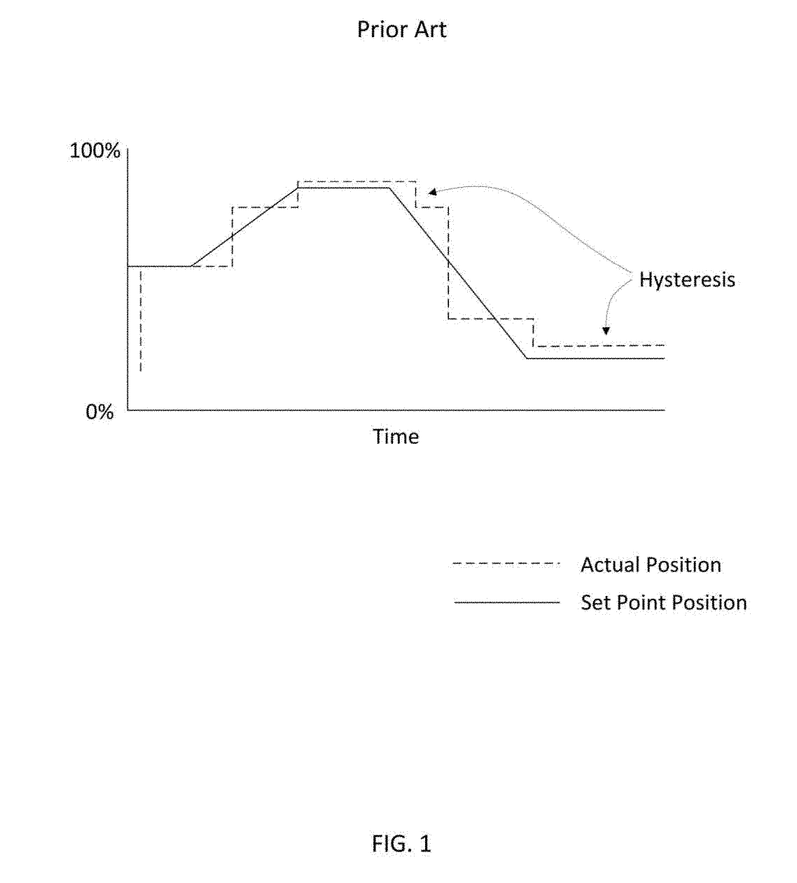

The valves may be arranged in parallel but other arrangements are also possible. The lines of FIG. 1 represent conduits which may carry substances such as liquid nitrogen, carbon dioxide, or other substances. The conduits may also have valves which use the methods that are described herein. A group of valves for purposes of this disclosure may be valves that are tuned to function within a certain phase shift and may be similar in structure. The valves may be within 0.1-100 feet of each other. The valves may receive the same input conduit that then branches off to feed into the valves and then the output of the valves feed into the same conduit or feed into the same vessel. A system may have multiple groups of valves that use the oscillating method with phase shift.

In some embodiments the vessel containing liquid nitrogen may travel through a conduit, and the conduit may then branch off so that substances may be carried through the conduit or conduits through the valves that are in parallel, as will be described elsewhere in this application. The valves may oscillate in a pattern between on or off. As described earlier, an on or off position may include various gradations such that a valve in an off or closed position is relatively closed or at the maximum closed level for a cycle. For example, if the set point is 60% and the oscillating margin is 15%, then at 45% open the valve would be at its maximum close position for that setting. Any references to cycling or oscillating between open and close positions may refer to the relatively closed or relatively open position and may not necessarily require that the valve be 100% open or 100% closed. FIG. 2 shows a system that has two valves, and the valves may be oscillating with a phase shift of 180 degrees. In such a method when the first valve is open at its peak (which is not necessarily fully open), then the second valve may be closed at its peak (which is not necessarily fully closed, as discussed previously). In some embodiments the phase shift of the oscillation between the at least two valves may eliminate or decrease the effect of oscillation, if any oscillation side effect is observed or observable. Returning to FIG. 2, a conduit leads from the at least two valves (here two valves but may be more than 2 valves) to a heat exchanger or other vessel. The upper line with an arrow on the end of it may indicate, in some embodiments, a conduit for substances, such as liquid nitrogen, that didn't leave the heat exchanger and those substances may then be emptied into the atmosphere or may be used in other processes. In some embodiments after the fluid or gas has entered the heat exchanger, other conduits may then carry the liquid nitrogen or other substances through other devices and as shown in FIG. 2 a thermal coupler (206) is shown and in the upper conduit that leads the heat exchanger as shown in FIG. 2 caries process fluid away from the heat exchanger. Although the heat exchanger is given as an example, any other variety of apparatuses or devices that are commonly used for energy sustainability or processing of liquids or gases may also be used.

The valves may oscillate between 20% open to 80% open or may oscillate between 5% open to 95% open or may oscillate between 50% open to 80% open and in the preferred embodiments there are at least two valves and the valves oscillate with a phase shift that is calculated or may be calculated by the following algorithm 360/n where n equals the number of valves. So in a two valve system, the phase shift is 360/2 or 180 degrees.

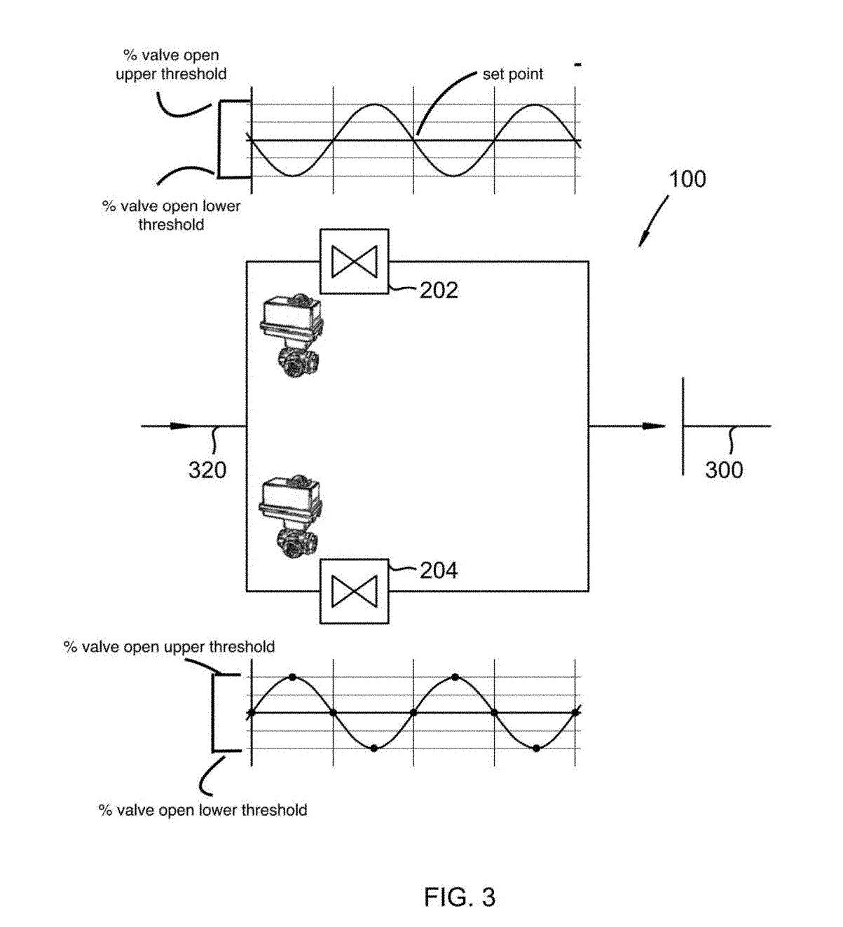

Referring to FIG. 3, a system is shown. The system is similar to FIG. 2. The sine waves are representative of the open-closed state of the valve. The upper sine wave curve represents one possible open-closed state curve for the first valve, which is depicted as the upper valve. The lower sine wave curve represents one possible open-closed state curve for the second valve, which is depicted as the lower valve. In the two graphs shown in FIG. 3, the X axis represents time and the Y axis represents the open-closed state of the graph. The midpoint of the Y axis represents 50% open; the upper part of the Y axis represents 100% open and the lower part represents 0% open. The sine waves in FIG. 3 oscillate approximately between 20% open to 80%; the phase shift with 2 valves is depicted such that when the first valve is at its maximum open position (here 80%), the other valve is at its minimum open position (here 20%). In some embodiments, the phase shift between two or more oscillating valves may minimize or even eliminate the effects of oscillation. Oscillation of the valves may cause some kind of effect in itself that may cause the average open position of the valve to differ from the desire or instructed average open position. To the right of FIG. 3 is an “empty” graph (300) which may be representative of a “canceling” effect such that the phase shift of the oscillating valves may cancel or at least reduce the side effect of any oscillation on the overall output of the valves in the system (that is the average open-close position of the valves). Graph (300) represents that the side effects of oscillation, that is generating an error due to the oscillation, may be canceled out in that a first error value such as +1% and caused by a first oscillating valve may be canceled out by a second error value of 1% caused by a second valve oscillating in a phase shift compared to the first oscillating valve. In some embodiments, there may be a difference in the actual open-close positions during oscillation and the instructed positions. For example, the master controller may instruct a valve to be between 30% and 70%, but the valves may open roughly 29.5%-30.5% and 69.5% to 70.5%. However, by having a plurality of valves, the other valve(s) and their oscillation in a phase shift may serve to bring the average between the two or more valves closer to the desired open-close state. A conduit (320) carrying a substance, such as liquid nitrogen, branches and feeds into the two valves. A conduit (330) may then carry the substances, such as the liquid nitrogen, to a chamber.

In some embodiments, the phase shift may be calculated by a formula different than 360/n. For example, the algorithm may be 360/n−(a number between 0.1 and 50). For 2 valves, the phase shift could be the 180 degrees −5 degrees or 175 degrees. In some embodiments, the valves may not necessarily have the same structure and thus may not function exactly the same. In this scenario, a phase shift of 180 degrees may not lead to the cancelation of the oscillations, and different amplitudes for the valves may be optimal. For the valve that may suffer more from the effects of stiction and hysteresis, then it may be preferred to have that valve begin oscillating before the other valve(s).

In some embodiments, valves might not be identical so even with phase-shifting of 180 degrees, the side effects of oscillations may be visible. If that is the case, a different amplitude for each valve may be desirable. The method may include valve tuning, which may include running the system with all of the valves at the same output, measuring the output, and then changing the amplitude of the sine waveform for a single valve by 1%, 2%, or between 3% and 15% and then determining if the effect of the oscillation (that is deviating from the desired value) decreases. Initially, the system may change the amplitude by 10% and test the output, and then change the amplitude by +2% (like 12%), test the output, and try −2% (like 8%). In a tuning method, the system may adjust the amplitude of each valve until the side effects of oscillations have been decreased (the system may run a program to open and close valves without oscillating, and then compare the difference in the valve responsiveness by comparing to a program that oscillates with phase shifting).

In some embodiments, the instructions for oscillating, stored on the non-transitory storage unit and used by a processor to determine the control instructions for valves, may be less than or greater than a phase shift, such as for 2 valves having the phase shift be 179 degrees, 178 degrees, any number between 160 degrees and 180 degrees, any number between 179.1 and 179.9 degrees. In some embodiments, the system may use a sine wave oscillation pattern for a first valve that is not a complete phase shift designed for canceling out the sine wave oscillation pattern for a second valve, and the system may introduce a greater or lesser lag in the oscillation of the second valve (or third or other valve if greater than 2 valves are in the system); in which less of a lag may benefit the valve that is suffering from the effects of hysteresis and stiction more than the other valve(s) in the group. The master processor, by commanding a valve to oscillate a little sooner than it would under normal phase shifting, then the effect of two similar valves, in which the first valve is slower than the second valve, may be overcome or alleviated.

The next section describes a method for making the waveforms.

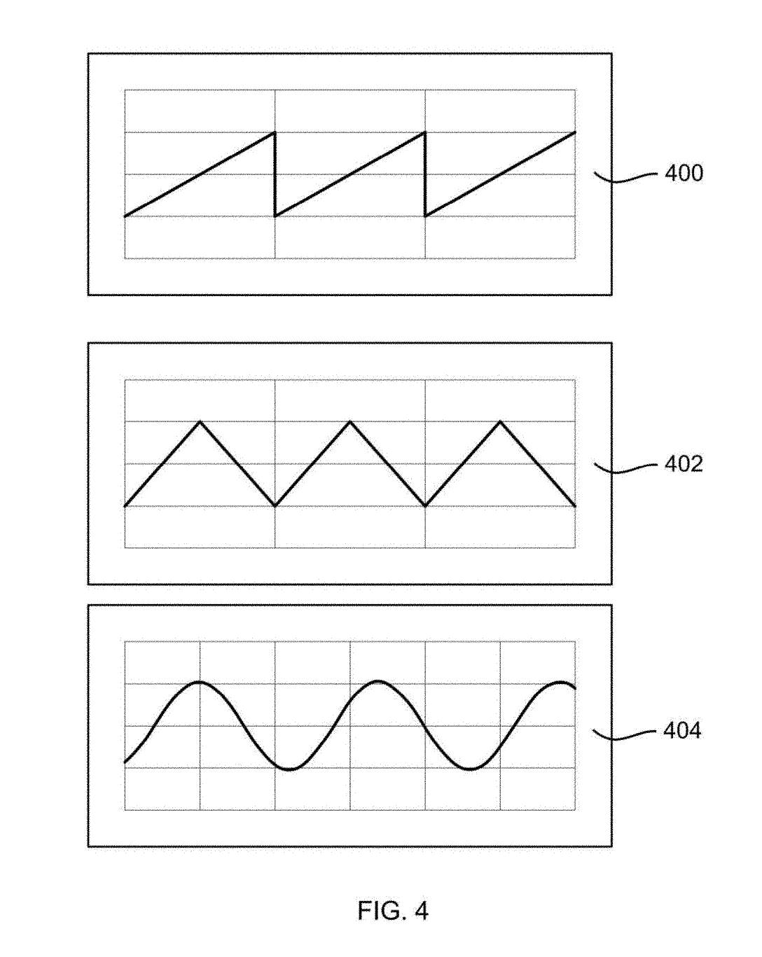

Let t be a variable that represents a periodic sawtooth wave in time, as shown in FIG. 4, graph 400:

Starting with an initial value, such as 1, the value of t at any time can be calculated from the previous value of t using a computer routine such as the following, where dt is the time since the last call of the routine, and p is the period of the sawtooth wave (dt is required to be less than p). The initial value and maximum value (−1 and 1) are arbitrary:

t := t + dt / p
if t > 1 then

t := t − 2

end if

From t, a variable y can be calculated using a mapping function to generate any kind of waveform, which is then added to the output of the PID controller. Continuing with our sawtooth wave example above, a triangle wave can be generated using the mapping function:

$$y = \{ \begin{matrix}2 t + 1 , t < 0 \\ 2 t + 1 , t \geq 0\end{matrix}$$

Which could be calculated in a computer routine by:

if t < 0 then

y := 2 * t + 1

else

y := −2 * t + 1

end if

Which yields the waveform (FIG. 4, graph 402):

A sine waveform can also be generated using a piecewise cubic polynomial approximation:

$$y = \{ \begin{matrix}4 {t}^{3} + 12 {t}^{2} + 9 t + 1 , & t < 0.5 \\ 4 {t}^{3} + 3 t , & 0.5 \leq t < 0.5 \\ 4 {t}^{3} 12 {t}^{2} + 9 t 1 , & t \geq 0.5 \end{matrix}$$

Which could then be calculated in a computer routine by:

if t < −0.5 then

y := 1 + t * (9 + t * (12 + t * 4))

else if t < 0.5 then

y := t * (3 − 4 * t * t)

else

y := −1 + t * (9 + t * (−12 + t * 4))

end if

Which yields the waveform 404 of FIG. 4:

Two or more waveforms can be generated out of phase, such as when using multiple valves in parallel as in FIG. 3:

One way of doing this is by introducing a new variable t′:

t := t + dt / p
if t > 1 then

t := t − 2

end if
t_prime := t

Then, for each of the n waveforms, the following routine incrementally offsets the phase by 360°/n. We use the triangle waveform in this example:

if t_prime < 0 then

y_1 := 2 * t_prime + 1

else

y_1 := −2 * t_prime + 1

end if
t_prime := t_prime + 2 / n
if t_prime < 0 then

y_2 := 2 * t_prime + 1

else

y_2 := −2 * t_prime + 1

end if
t_prime := t_prime + 2 / n

Repeated n Times

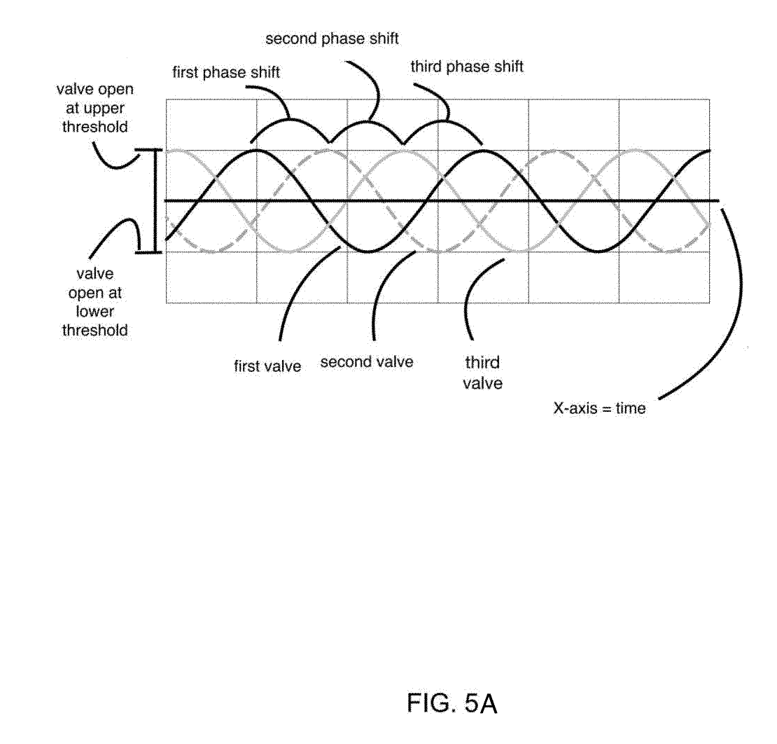

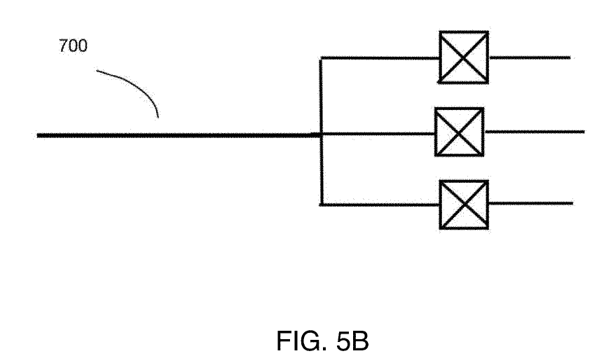

For example, if we used the sine waveforms with n=3, the following three waveforms of FIG. 5 would result; the three waveforms represent the sine curves of the open-close state of three different valves. The phase shift for 3 valves is shown and equals 120 degrees. The disclosure covers systems with up to 100 trillion valves, but the preferred number of valves for the system are inclusively between 2 and 100.

Referring to FIG. 5B, a conduit (700), such as a pipe, that branches into a total of three conduits, is depicted. The three conduits may each include a valve; and the valves may be opened and closed in a coordinated pattern, such that the oscillating pattern of second valve is a positive phase shift of the first valve's oscillating pattern and the oscillating pattern of the third valve is a positive phase shift of the second valve's oscillating pattern. Similar setups, with an additional conduit for each additional valve, may be used when the group of at least two valves includes more than three valves. Other setups in other embodiments may be used.

Various methods are contemplated including:

A method for overcoming hysteresis and stiction in a plurality of valves comprising: providing a plurality of valves comprising a positioner, an actuator, and an aperture area (referring to an area of the valve that defines an aperture, such as a section of the valve abutting an elongated conduit such as a pipe and consisting of a cross-section of the pipe); determining a set point for the at least two valves which is between 5 and 90%; determining a margin between 1% and 30%; oscillating a first valve of the at least two valves, using a sine wave pattern, between the set point minus the margin and the set point plus the margin, wherein the oscillation occurs at a time interval less than 10 seconds; and, oscillating a second valve of the at least two valves, using a sine wave pattern, between the set point minus the margin and the set point plus the margin, wherein the oscillation pattern of the first valve is a first phase shift of the oscillation pattern of the second valve.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope. In some instances, numerical values are used to describe features such as set points, margins, spreading factors, output power, bandwidths, link budgets, data rates, and distances. Though precise numbers are used, one of skill in the art recognizes that small variations in the precisely stated values do not substantially alter the function of the feature being described. In some cases, a variation of up to 50% of the stated value does not alter the function of the feature. Thus, unless otherwise stated, precisely stated values should be read as the stated number, plus or minus a standard variation common and acceptable in the art. The term number when used in the claims and similarly used in the specification means “one or more” of an object; for example, a number of widgets refers to one widget, two widgets, or more than two widgets.

To achieve its desired functionality, the computing device (1000) may include various hardware components. Among these hardware components may be a number of processors (1001), a data storage device (1002), a number of peripheral adapters (1004), and a number of network adapters (1003). These hardware components may be interconnected through the use of a number of buses and/or network connections. In one example, the processor (1001), data storage device (1002), peripheral device adapters (1004), and network adapter (1003) may be communicatively coupled via a bus (1005).

The computing device (1000) may include various types of memory modules, including volatile and nonvolatile memory. For example, the data storage device (1002) may include Random Access Memory (RAM) (1006), Read Only Memory (ROM) (1007), and Hard Disk Drive (HDD) memory (1008). Many other types of memory may also be utilized, and the present specification contemplates the use of as many varying types) of memory in the computing device (1000) as may suit a particular application of the principles described herein. In other examples, different types of memory in the computing device (1000) may be used for different data storage needs. In some examples, the processor (1001) may boot from Read Only Memory (ROM) (1007), maintain nonvolatile storage in the Hard Disk Drive (HDD) memory (1008), and execute program code stored in Random Access Memory (RAM) (1006).

Generally, the computing device (1000) may comprise a computer readable medium, a computer readable storage medium, or a non-transitory computer readable medium, among others. For example, the computing device (1000) may be, but is not limited to, an electronic, magnetic, optical, electromagnetic, infrared, or semiconductor system, apparatus, or device, or any suitable combination of the foregoing. More specific examples of the computer readable storage medium may include, for example, the following: an electrical connection having a number of wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain or store computer usable program code for use by, or in connection with, an instruction execution system, apparatus, or device. In another example, a computer readable storage medium may be any non-transitory medium that can contain or store a program for use by, or in connection with, an instruction execution system, apparatus, or device.

The hardware adapters (1003, 1004) in the computing device (1000) enable the processor (1001) to interface with various other hardware elements, external and internal to the computing device (1000). The peripheral device adapters (1004) may provide an interface to input/output devices, such as a radio transmitter (1009), to communicate with a remote device. The peripheral device adapters (1003) may also provide access to other external devices, such as an external storage device, a number of network devices, such as servers, switches, and routers, client devices, other types of computing devices, or combinations thereof.

1. A method for overcoming hysteresis and stiction in a plurality of N valves comprising:
providing a total of N valves, wherein N is less than 101 and is equal to the total number of valves in the plurality of N valves, directly coupled by a single conduit which branches and feeds into each valve of the N valves, wherein each valve of the N valves comprises a body, an aperture area disposed within the body and defining an aperture, a modulating element disposed within the body and configured to occlude a percentage of the aperture, the positioner, the actuator, and the aperture area;
determining a set point for the plurality of N valves which is between 5% fully-opened and 90% fully-opened;
determining an upper threshold substantially equal to 100% minus the percentage of the aperture occluded by the modulating element for the plurality of N valves;
determining a lower threshold substantially equal to 100% minus the percentage of the aperture occluded by the modulating element for the plurality of N valves;
oscillating each valve of the plurality of N valves, according to an instruction received from a server to oscillate according to a Nth valve oscillating pattern, continuously for a time interval, back and forth from an upper threshold to a lower threshold, wherein the average of the upper threshold and the lower threshold is substantially equal to a set point;
arranging the oscillating pattern for each valve of the plurality of N valves in temporal order so that a first instant in time at which the first valve of the plurality of N valves begins to transition from the upper threshold to the lower threshold is temporally followed, at a second instant in time, by a second valve of the plurality of N valves beginning to transition from the upper threshold to the lower threshold so that the phase shift as measured between the oscillating pattern of the first valve at the first instant in time and the oscillating pattern of the second valve at the second instant in time substantially equals 360/N degrees, wherein the phase shift between the Nth valve and the first valve is substantially equal to 360/N degrees.

2. The method of claim 1 wherein N equals 2, the phase shift equals 180 degrees, and the instruction received from the server is received wirelessly.

3. The method of claim 1 wherein N equals 3 and the phase shift equals 120 degrees.

4. The method of claim 3 wherein the first valve, second valve, and third valve are proportional valves arranged in a parallel alignment, and the method of claim 3 further comprises the step of outputting the set point from a PID controller and tuning the first valve, second valve, and third valve.

5. The method of claim 5, wherein the phase shift is defined as 360/N degrees minus a number of degrees between 0.1 degrees and 7 degrees.

6. The method of claim 4, further comprising the steps of monitoring, via a sensor, the actual aperture areas of the first valve and the second valve; comparing, via a server, the actual aperture areas of the first valve and the second valve to the set point.

7. The method of claim 1, comprising the steps of providing a jumbo valve comprising the first valve and the second valve, wherein the first valve and the second valve reside in a single casing.

8. The method of claim 1, wherein N equals 2, and wherein the set point of the first valve is between 1.1 and 1.3 times larger than the set point of the second valve.

9. The method of claim 8 further comprising the steps of monitoring, via a sensor, the actual aperture areas of the first valve and the second valve; comparing, via a server, the actual aperture areas of the first valve and the second valve to the set point.

10. A apparatus for overcoming hysteresis and stiction comprising:
a plurality of N oscillating valves in a group, grouped by proximity, input conduit or identical substance passing through the valves, wherein N is equal to the total number of valves in the plurality of valves, wherein each valve of the plurality of N oscillating valves comprises a positioner, an actuator, and an aperture area and each of the N oscillating valves is configured to oscillate at a phase shift of 360/N degrees from at least one of the other valves in the group;
a server communicatively coupled to a processor; the processor communicatively-coupled to a non-transitory data storage unit;
the non-transitory data storage unit comprising computer code that, when executed by the processor, causes the processor to:
determine a set point for the plurality of N valves which is between 5% fully-opened and 90% fully-opened;
determine an upper threshold substantially equal to 100% minus the percentage of the aperture occluded by the modulating element for the plurality of N valves;
determine a lower threshold substantially equal to 100% minus the percentage of the aperture occluded by the modulating element for the plurality of N valves;
instruct, via a server, each valve of the plurality of N valves, to oscillate according to a Nth valve oscillating pattern, continuously for a time interval, back and forth from an upper threshold (for the percentage that the aperture is opened as compared to the maximum value that the aperture may be opened) to a lower threshold, wherein the average of the upper threshold and the lower threshold is substantially equal to a set point;
arranging the oscillating pattern for each valve of the plurality of N valves in temporal order so that a first instant in time at which the first valve of the plurality of N valves begins to transition from the upper threshold to the lower threshold is temporally followed, at a second instant in time, by a second valve of the plurality of N valves beginning to transition from the upper threshold to the lower threshold so that the phase shift as measured between the oscillating pattern of the first valve at the first instant in time and the oscillating pattern of the second valve at the second instant in time substantially equals 360/N degrees, wherein the phase shift between the Nth valve and the first valve is substantially equal to 360/N degrees.

11. The apparatus of claim 10 wherein the first phase shift is 180 degrees.

12. The apparatus of claim 10 further comprising a third valve, the non-transitory data storage medium further storing programmable instructions for continuously oscillating the third valve, using an oscillating pattern, from the upper threshold to the lower threshold, wherein the phase shift between the first oscillation pattern and the second oscillation pattern is 120 degrees, wherein the phase shift between the second oscillation pattern and the third oscillation pattern is 120 degrees.

13. The apparatus of claim 12 wherein the first valve, second valve, and third valve are proportional valves arranged in a parallel alignment, the apparatus further comprising a proportional-integral-derivative controller configured to output a data value equal to the set point.

14. The apparatus of claim 13 wherein the set point is between 47% and 53%.

15. The apparatus of claim 13, wherein the phase shift is defined as ((360 degrees divided by N) minus a number of degrees between 0.1 degrees and 7 degrees).

16. The apparatus of claim 10, wherein N equals 2, further comprising a jumbo valve, the jumbo valve consisting of a casing surrounding the first valve and the second valve.

17. The apparatus of claim 11 wherein the difference between the upper threshold and the set point is between 0.1% and 11% and the difference between the set point and the lower threshold is between 0.1% and 11%, and wherein the non-transitory medium stores instructions for instructing the set point of the second valve to be between 1.1 and 1.3 times larger than the set point of the first valve.

18. A apparatus for overcoming hysteresis and stiction comprising:
at least two valves, wherein each valve of the at least two valves comprises a positioner, an actuator, and an aperture area (referring to an area of the valve that defines an aperture, such as a section of the valve abutting an elongated conduit such as a pipe and consisting of a cross-section of the pipe);
a processor communicatively-coupled to a non-transitory data storage unit;
the non-transitory data storage unit comprising computer code that, when executed by the processor, causes the processor to
determine or confirm a set point for the valve which is between 25% and 67% (or between 2% and 98%).

19. The apparatus of claim 18 wherein the set point for each valve is between 30% and 62%.

20. The apparatus of claim 18 wherein the set point for the valve is between 40% and 57%.
